(19) United States
(12) Patent Application Publication
(10) Pub. No.: US 2025/0273209 A1
(43) Pub. Date: Aug. 28, 2025

(54) DIALOG SYSTEM USING MAPPING OF USER INTENT

(71) Applicant: SK TELECOM CO., LTD., Seoul (KR)

(72) Inventors: Tae Wook KIM, Seoul (KR); Won Woo KIM, Seoul (KR); Jeong Young KIM, Seoul (KR); Yong Soo SEOL, Seoul (KR); Seung Jun LEE, Seoul (KR)

(21) Appl. No.: 18/856,527

(22) PCT Filed: Mar. 30, 2023
(86) PCT No.: PCT/KR2023/004271

§ 371 Date: Oct. 11, 2024

(30) Foreign Application Priority Data
Apr. 22, 2022 (KR) 10-2022-0049933

(51) Int. Cl. G10L 15/22; G10L 15/02; G10L 15/183

(52) U.S. Cl. CPC G10L 15/22; G10L 15/02; G10L 15/183

(57) ABSTRACT

A dialogue system using mapping of user intent is disclosed. The dialog system uses a method for, in generation of a dialog scenario, expressing user intent on the basis of mapping. The dialog system may efficiently and intuitively describe the dialog scenario corresponding to various user input patterns.

### TECHNICAL FIELD

The present disclosure relates to a to a dialog system using mapping of user intent.

### BACKGROUND

The statements in this section merely provide background information related to the present disclosure and do not necessarily constitute prior art.

Conventional dialog systems (for example, Google's Dialogflow CX, Amazon's Lex, and the like) express user intent as an intent based on natural language understanding (NLU) analysis, as illustrated in FIG. 1. The intent may be used as key conditions when a chatbot executes a specific action or transition of a dialog state.

It is possible to design a dialog flow using only intent based on the NLU analysis. However, when a complex dialog flow is designed, there may be limitations in expressiveness. When user intent is expressed, there may be cases where it is expressed in too much detail or abstractly. When intent occurs under a specific context, there may also be situations where the expression is impossible. For example, “like” in response to a confirmation request and “like” in chat may have different meanings. Additionally, there are cases where the intent of expressions related to negative interrogates is reversed depending on the dialog state. For example, in response to “Aren't you Gil-dong Hong?”, “Yes” may be interpreted as a negative. In other words, it may be difficult to make a distinction based on the intent of the NLU alone. Due to these limitations in intent expressiveness, the generation of dialog scenarios becomes complicated when a dialog system is implemented, and the resulting dialog may become unintuitive.

The above-described issue may become more severe when a plurality of pieces of user intent are analyzed. The plurality of pieces of user intent are analyzed in the form of a combination of pieces of intent (for example, a list). The expressiveness issue of intent may become more severe as the combination becomes more complex. When a dialog scenario is generated utilizing the combination of pieces of intent, a wide variety of scenario branching conditions needs to be described to respond to various input combinations.

Accordingly, there is a need to consider a dialog system that uses a method of efficiently expressing user intent to overcome the limitations of intent expressiveness according to the NLU analysis and to process a plurality of pieces of user intent.

### DISCLOSURE

### Technical Problem

The present disclosure seeks to provide a dialog system using a method for, in generation of a dialog scenario, expressing user intent based on mapping. The dialog system may efficiently and intuitively describe the dialog scenario corresponding to various user input patterns.

### Technical Solution

At least one aspect of the present disclosure provides a method for expressing, by a dialog system, intent included in an utterance of a user. The method includes extracting at least one piece of natural language understanding (NLU) intent from the utterance of the user. The method also includes mapping each of the at least one piece of NLU intent to dialog manager (DM) intent. When a plurality of pieces of the NLU intent is extracted from the utterance of the user, the method further includes generating a DM intent list. Here, the DM intent list includes the DM intent mapped to each of the plurality of pieces of the NLU intent. The method further includes performing a multi-intent mapping on a plurality of pieces of the DM intent included in the DM intent list.

Another aspect of the present disclosure provides a dialog system. The dialogue system includes a natural language understanding (NLU) module configured to extract at least one piece of NLU intent from an utterance of a user. The dialogue system also includes an intent mapping module configured to map each of the at least one piece of NLU intent to dialog manager (DM) intent, and generate a DM intent list when a plurality of pieces of the NLU intent is extracted from the utterance of the user. Here, the DM intent list includes the DM intent mapped to each of the plurality of pieces of the NLU intent. The dialogue system also includes a multi-intent mapping module configured to perform multi-intent mapping on a plurality of pieces of the DM intent included in the DM intent list.

Yet another aspect of the present disclosure provides a computer-readable recording medium storing instructions. The instructions, when executed by the computer, cause the computer to extract at least one piece of natural language understanding (NLU) intent from an utterance of a user. The instructions also cause the computer to map each of the at least one piece of NLU intent to dialog manager (DM) intent. When a plurality of pieces of the NLU intent is extracted from the utterance of the user, the instructions further cause the computer to generate a DM intent list. Here, the DM intent list includes the DM intent mapped to each of the plurality of pieces of the NLU intent. The instructions further cause the computer to perform multi-intent mapping on a plurality of pieces of the DM intent included in the DM intent list.

### Advantageous Effects

As described above, the present disclosure provides a dialog system using a method for, in generation of a dialog scenario, expressing user intent based on mapping. Thus, the dialog system efficiently and intuitively describe the dialog scenario corresponding to various user input patterns.

In addition, the present disclosure provides a dialog system using a method for, in generation of a dialog scenario, expressing user intent based on mapping, so that a plurality of pieces of user intent can be processed efficiently.

### BRIEF DESCRIPTION OF THE DRAWINGS

FIG. 1 is an exemplary diagram illustrating a conventional dialog system.

FIG. 2 is an exemplary diagram illustrating a dialog system according to an embodiment of the present disclosure.

FIG. 3 is an exemplary diagram illustrating intent mapping according to an embodiment of the present disclosure.

FIG. 4 is an exemplary diagram illustrating multi-intent mapping according to an embodiment of the present disclosure.

FIG. 5 is a flowchart illustrating a method of expressing intent according to an embodiment of the present disclosure.

### DETAILED DESCRIPTION

Hereinafter, some embodiments of the present disclosure will be described in detail with reference to the accompanying illustrative drawings. In the following description, like reference numerals preferably designate like elements, although the elements are shown in different drawings. Further, in the following description of some embodiments, a detailed description of related known components and functions when considered to obscure the subject of the present disclosure will be omitted for the purpose of clarity and for brevity.

Additionally, various terms such as first, second, A, B, (a), (b), etc., are used solely to differentiate one component from the other but not to imply or suggest the substances, order, or sequence of the components. Throughout this specification, when a part “includes” or “comprises” a component, the part is meant to further include other components, not to exclude thereof unless specifically stated to the contrary. The terms such as “unit,” “module,” and the like refer to one or more units for processing at least one function or operation, which may be implemented by hardware, software, or a combination thereof.

The present embodiment discloses a dialog system using mapping of user intent. More specifically, the present embodiment provides a dialog system using a method for, in generation of a dialog scenario, expressing user intent based on mapping in order to efficiently and intuitively describe the dialog scenario corresponding to various user input patterns.

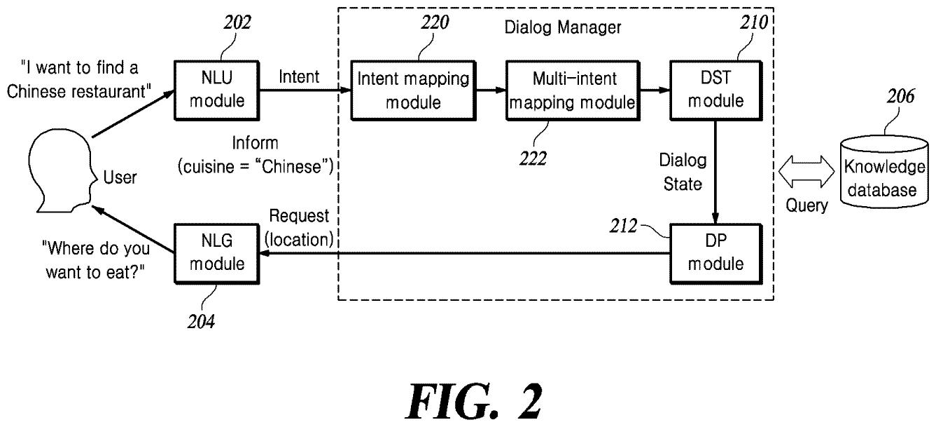

FIG. 2 is an exemplary diagram illustrating a dialog system according to an embodiment of the present disclosure.

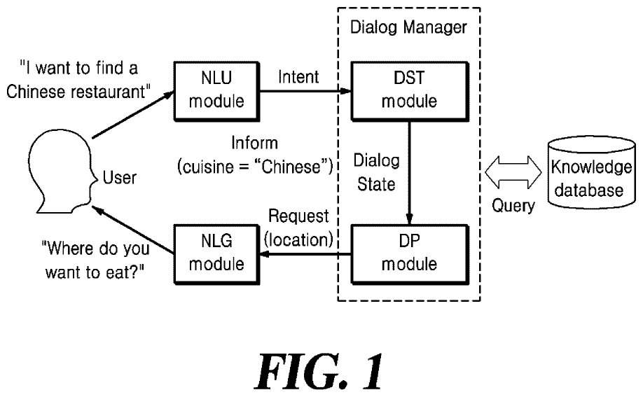

The dialog system according to an embodiment of the present disclosure includes all or part of a natural language understanding (NLU) module 202, a natural language generating (NLG) module 204, a dialog manager (DM), and a knowledge database 206 illustrated in FIG. 1. Here, the DM further includes an intent mapping module 220 and a multi-intent mapping module 222 in addition to a dialog state tracking (DST) module 210 and a dialog policy (DP) module 212.

The illustration in FIG. 2 is an exemplary configuration according to an embodiment of the present disclosure. It is possible to implement various dialog systems that include different components or different connections between components depending on the structure and operation of the NLU module, the structure and operation of the NLG module, the structure and operation of the DM, and the structure of the knowledge base.

In the dialog system, the NLU module 202 analyzes the input utterance of a user and derives intent indicating the purpose of a user utterance. The NLU module 202 may derive an entity, which is additional information in addition to the intent. Analysis data such as intent and entity is delivered to the DM. In the example of FIG. 2, the NLU module 202 generates ‘Chinese’ indicating the type of restaurant as intent of the user utterance.

The DM operates the DST module 210 and the DP module 212 based on the analysis data delivered from the NLU module 202. The DST module 210 maintains state variables such as history of dialog state, recent unanswered user questions, and the like. The DP module 212 uses the state variables tracked by the DST module 210 and a query with the knowledge database 206 to generate semantic representation to generate an answer that meets user intent. In the example of FIG. 2, the DM generates the semantic representation that includes the location of a restaurant conditioned on the user intent.

The NLG module 204 generates a text sentence based on the semantic representation generated from the DM and provides the text sentence to a user.

The knowledge database 206 stores knowledge necessary to generate the semantic representation that matches the user intent from entities and intent. For example, the intent and entity may correspond to conditions, the semantic representation may be an answer that matches the conditions. The knowledge database 206 may include various pieces of data to mediate between the two.

Hereinafter, the operations of the intent mapping module 220 and the multi-intent mapping module 222, which are components added to the DM according to an embodiment of the present disclosure, are described.

As described above, the NLU module 202 derives an entity that is additional information in addition to the intent indicating the utterance intent of a user. When a user utterance includes a plurality of pieces of intent, the NLU module 202 may generate analysis results corresponding to the number of intent. For example, in response to the user utterance, “I have a fever of about 38 degrees, please wait a moment,” the NLU module 202 may generate the following analysis results.

“I have a fever of about 38 degrees.”=> {“intent”: “inform.fever.yes”, “entities”: [{“type”: “temperature”, “value”: “38 degrees”}]}

“Please wait a moment”=> {“intent”: “ask.wait”}

In the above example, it is assumed that the NLU module 202 analyzes a plurality of pieces of intent for one given sentence, but this may vary depending on the structure and operation characteristics of the NLU module 202. For example, when the NLU module 202 that analyzes one intent per sentence is used, the same result may be acquired by first performing sentence separation and then obtaining the intent for each separated sentence. The analyzed results are delivered to the intent mapping module 220 within the DM, as described above.

The intent mapping module 220 intent-maps each of at least one piece of intent (hereinafter, “NLU intent”) analyzed in the NLU module 202 to the intent in the DM (hereinafter, “DM intent”). Accordingly, intent mapping may be a decision that expresses the interpretation of the NLU intent under the current context.

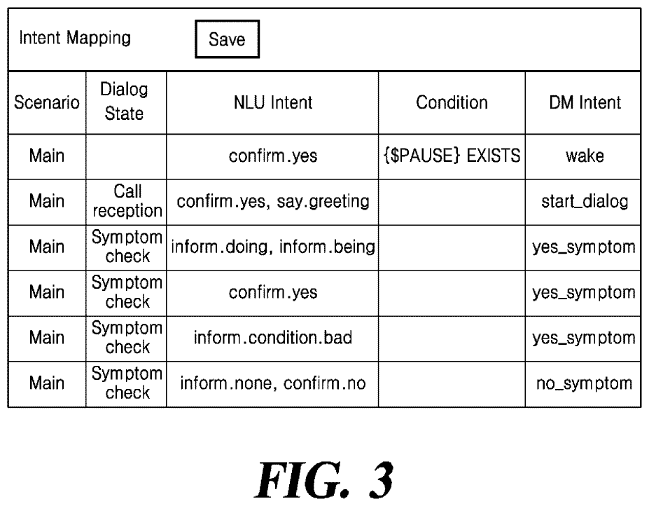

FIG. 3 is an exemplary diagram illustrating intent mapping according to an embodiment of the present disclosure.

Depending on the specific context (for example, dialog scenario and dialog state), condition information obtained during the dialog, and the like, after preset mapping rules are defined as illustrated in FIG. 3 regarding which DM intent the NLU intent corresponds to, the intent mapping module 220 may perform the intent mapping using these mapping rules.

By performing the intent mapping, the intent mapping module 220 may generate the DM intent that is abstracted and detailed compared to the NLU intent. Accordingly, the DM intent may be more expressive about user intent. When a plurality of pieces of NLU intent is interpreted as the same intent in a specific context, the plurality of pieces of NLU intent may be abstracted into a single piece of DM intent. On the other hand, when the NLU intent is the same but needs to be interpreted differently depending on the context or condition information, the user intent may be detailed using the DM intent.

Intent may be used as branching conditions for dialog scenarios within the DM. As described above, when the DM intent is introduced and used, there are two advantages as follows. First, when a dialog scenario is described, the number of required branching conditions may be much reduced. This is an advantage that may be acquired through intent abstraction. The second is the intuitiveness of branching conditions. For example, because “Like” needs to be interpreted differently in a confirmation request situation and a chat situation, a branching condition described using the DM intent may be more intuitive than a branching condition described using the NLU intent. This is an advantage that may be acquired by detailed intent.

When a plurality of pieces of user intent is input, the mapping result by the intent mapping module 220 may be given in the form of a list of the DM intent including a plurality of pieces of DM intent. This DM intent list may be delivered to the multi-intent mapping module 222.

When the plurality of pieces of DM intent is analyzed according to a plurality of pieces of intent included in a user utterance, the DM may basically sequentially execute actions corresponding to each piece of the DM intent. However, depending on a combination of the input DM intent, the DM may select one of several pieces of the DM intent (for example, in a confirmation request situation, when the response is “That's right, just wait a moment,” the system ignores the response and wait) or may convert the same into new DM intent, and then may execute the corresponding action.

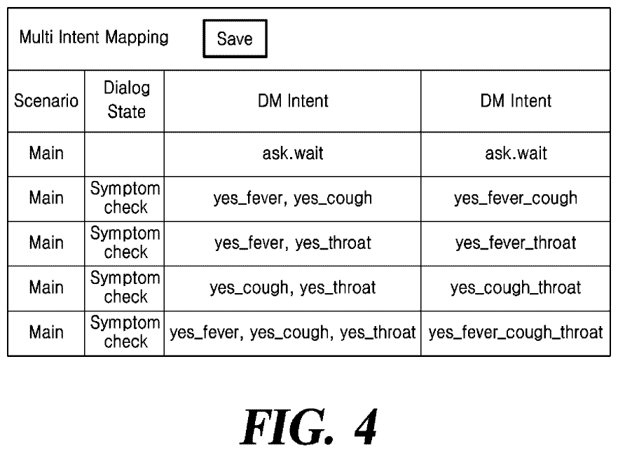

Hereinafter, an example in which the multi-intent mapping module 222 performs multi-intent mapping is described using the example of FIG. 4.

FIG. 4 is an exemplary diagram illustrating multi-intent mapping according to an embodiment of the present disclosure.

It is assumed a situation where a slot-filling dialog is held about “fever,” “cough,” or “sore throat” to examine coronavirus symptoms. In addition, it is assumed that a system action (guided utterance for fever symptoms) when a user responds to a fever symptom and a system action (guided utterance for cough symptoms) when the user responds to a cough symptom are defined. In this connection, when the user responds to fever and cough symptoms at the same time, the actions corresponding to each may be executed sequentially (for example, if you have a fever, please . . . , and if you have a cough, please . . . ). However, generating and providing separate guide utterances (for example, when you have a fever and cough, please . . . ) may provide a better user experience. In this connection, as shown in the second row of the multi-intent mapping rule example illustrated in FIG. 4, the multi-intent mapping module 222 may integrate the fever symptom-related intent (yes_fever) and the cough symptom-related intent (yes_cough) to generate new DM intent (yes_fever_cough) and then may deliver the new DM intent to the next stage. In this connection, the action corresponding to the new DM intent may be a separate guide utterance for both fever and cough symptoms.

As described above, when the DM intent list is processed and the multi-intent mapping is performed, the multi-intent mapping module 222 may condition whether the DM intent list input under a specific context is configured of a specific combination to select one piece of the DM intent. As another example, the multi-intent mapping module 222 may map this specific combination of the DM intent list to new DM intent.

As illustrated in FIG. 4, multi-mapping rules may be defined for the multi-intent mapping. In other words, the multi-mapping rule allocates the DM intent to be mapped when the condition is satisfied for conditions including a specific context (for example, dialog scenario and dialog state) and a pattern (a plurality of pieces of the DM intent) of the DM intent list.

Patterns (a plurality of pieces of the DM intent) of the DM intent list may be defined as shown in the example in Table 1.

TABLE 1

| Patterns | Description methods | Examples |
|---|---|---|
| All designated pieces of DM intent | Separate a plurality | A, B, and C |
| are present regardless of order | of pieces of DM | |
| | intent with (,) | |
| The designated pieces of DM intent | Separate a plurality | A > B |
| are present in the order described | of pieces of DM | |
| | intent with (>) | |

As exemplified in Table 1, patterns may be configured regardless of order, and in this connection, each piece of the DM intent may be separated by ‘,’. As another example, the patterns may be configured in the order described by a user, where each piece of the DM intent may be separated by, for example, ‘>’. Table 1 is an example of the simplest pattern, and more diverse patterns may be defined and used as needed.

For the DM intent list and a plurality of multi-mapping rules as illustrated in FIG. 4, the multi-intent mapping module 222 may apply the mapping rule that first matches the pattern of the DM intent list. As another example, after one mapping rule is applied, the multi-intent mapping module 222 may additionally check whether the remaining mapping rules are applied. In this connection, mapping rules that are checked to be applied later may include more pieces of the DM intent than previously applied mapping rules. When there are no more mapping rules to apply to the DM intent list, the multi-intent mapping module 222 delivers the checked mapping result to a subsequent DM stage (for example, the DST module 210). When there is no multi-mapping rule to apply to the DM intent list, the multi-intent mapping module 222 does not generate a result according to multi-intent mapping. In this connection, the DM may sequentially execute actions corresponding to each piece of the DM intent, as described above.

Using this multi-intent mapping, a combination of various pieces of the DM intent that satisfy the pattern may be converted into one piece of the DM intent and processed. In addition, using this mapping process, the multi-intent mapping module 222 may abstract the DM intent list once more.

One piece of the DM intent obtained based on intent mapping and multi-intent mapping according to this embodiment may cover a very large number of user input patterns. As a result, rather than processing a plurality of pieces of user intent with NLU intent, this embodiment may process a plurality of pieces of user intent in a more intuitive and efficient manner.

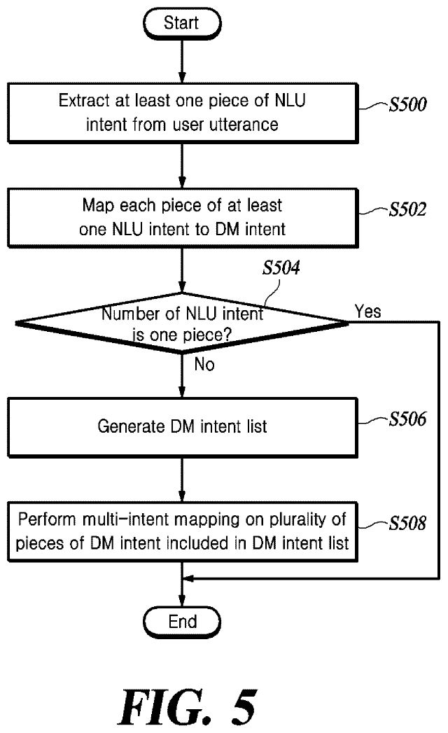

Hereinafter, a method of expressing intent included in a user utterance performed by a dialog system is described using the illustration of FIG. 5.

FIG. 5 is a flowchart illustrating a method of expressing intent according to an embodiment of the present disclosure.

The dialog system extracts at least one piece of the NLU intent from a user utterance (S500). The dialog system analyzes the input utterance of a user and derives the intent that indicates the purpose of the user utterance. The dialog system may derive entities, which are additional information in addition to the intent. Analysis data such as intent and entity is delivered to the DM within the dialog system.

The dialog system maps each piece of at least one NLU intent to the DM intent (S502). The dialog system maps the NLU intent to the DM intent according to a preset mapping rule for specific contexts and conditions acquired during a conversation with a user.

The preset mapping rule may abstract a plurality of pieces of the NLU intent into a single piece of the DM intent in the case of the plurality of pieces of the NLU intent being interpreted as the same intent in a specific context. Additionally, when the same NLU intent is interpreted differently depending on specific context or condition, the preset mapping rule may detail the intent of a user using the DM intent.

The dialog system checks the number of NLU intent (S504).

When the plurality of pieces of the NLU intent is extracted from a user utterance (No in S504), the dialog system may additionally perform the following stages.

The dialog system generates the DM intent list (S506). Herein, the DM intent list includes the DM intent mapped to each of the plurality of pieces of the NLU intent.

The dialog system performs the multi-intent mapping on the plurality of pieces of the DM intent included in the DM intent list (S508).

The dialog system performs the multi-intent mapping according to the matched multi-mapping rule among preset multi-mapping rules for conditions corresponding to the pattern of the DM intent list under a specific context. The dialog system may select one piece of the DM intent from the DM intent list or may map the plurality of pieces of the DM intent to new DM intent according to the matched multi-mapping rule.

The dialog system may apply the multi-mapping rule that matches first among the preset multi-mapping rules to the pattern in the DM intent list. The dialog system does not generate results according to the multi-intent mapping when none of the multi-mapping rules preset for the DM intent list match. In this connection, the dialog system may sequentially execute actions corresponding to each piece of the DM intent, as described above.

Although the steps in the respective flowcharts are described to be sequentially performed, the steps merely instantiate the technical idea of some embodiments of the present disclosure. Therefore, a person having ordinary skill in the art to which this disclosure pertains could perform the steps by changing the sequences described in the respective drawings or by performing two or more of the steps in parallel. Hence, the steps in the respective flowcharts are not limited to the illustrated chronological sequences.

Each component of the apparatus or method according to the present disclosure may be implemented as hardware or software or implemented as a combination of hardware and software. Further, a function of each component may be implemented as software, and a microprocessor may also be implemented to execute the function of the software corresponding to each component.

Various implementations of the systems and methods described herein may be realized by digital electronic circuitry, integrated circuits, field-programmable gate arrays (FPGAs), application-specific integrated circuits (ASICs), computer hardware, firmware, software, and/or their combination. These various implementations can include those realized in one or more computer programs executable on a programmable system. The programmable system includes at least one programmable processor coupled to receive and transmit data and instructions from and to a storage system, at least one input device, and at least one output device, wherein the programmable processor may be a special-purpose processor or a general-purpose processor. The computer programs (which are also known as programs, software, software applications, or code) contain instructions for a programmable processor and are stored in a “computer-readable recording medium.”

The computer-readable recording medium includes any type of recording device on which data that can be read by a computer system are recordable. Examples of computer-readable recording mediums include non-volatile or non-transitory media such as a ROM, CD-ROM, magnetic tape, floppy disk, memory card, hard disk, optical/magnetic disk, storage devices, and the like. Further, the computer-readable recording medium can be distributed in computer systems connected via a network, wherein the computer-readable codes can be stored and executed in a distributed mode.

Although embodiments of the present disclosure have been described for illustrative purposes, those having ordinary skill in the art to which this disclosure pertains should appreciate that various modifications, additions, and substitutions are possible, without departing from the idea and scope of the present disclosure. Therefore, embodiments of the present disclosure have been described for the sake of brevity and clarity. The scope of the technical idea of the embodiments of the present disclosure is not limited by the illustrations. Accordingly, those having ordinary skill in the art to which the present disclosure pertains should understand that the scope of the present disclosure should not be limited by the above explicitly described embodiments but by the claims and equivalents thereof.

### REFERENCE NUMERALS

202: NLU module
204: NLG module
206: knowledge database
210: DST module
212: DP module
220: intent mapping module
222: multi-intent mapping module

### CROSS-REFERENCE TO RELATED APPLICATIONS

This application claims priority to and the benefit of Korean Patent Application No. 10-2022-0049933, filed on Apr. 22, 2021, the entire disclosures of each of which are incorporated herein by reference.

1. A method for expressing, by a dialog system, intent included in an utterance of a user, the method comprising:
extracting at least one piece of natural language understanding (NLU) intent from the utterance of the user; and
mapping each of the at least one piece of NLU intent to dialog manager (DM) intent,
wherein, when a plurality of pieces of the NLU intent is extracted from the utterance of the user, the method further comprises:
generating a DM intent list, wherein the DM intent list includes the DM intent mapped to each of the plurality of pieces of the NLU intent; and
performing a multi-intent mapping on a plurality of pieces of the DM intent included in the DM intent list.

2. The method of claim 1, wherein mapping to the DM intent includes:
mapping the NLU intent to the DM intent according to a preset mapping rule for a specific context and condition acquired during a conversation with the user.

3. The method of claim 2, wherein the preset mapping rule abstracts the plurality of pieces of the NLU intent into a single piece of the DM intent when the plurality of pieces of the NLU intent is interpreted as the same intent in the specific context.

4. The method of claim 2, wherein the preset mapping rule details the intent of the user using the DM intent when the same NLU intent is interpreted differently depending on the specific context or the condition.

5. The method of claim 1, wherein performing the multi-intent mapping includes:
performing the multi-intent mapping according to a matched multi-mapping rule among preset multi-mapping rules for a condition corresponding to a pattern of the DM intent list under a specific context.

6. The method of claim 5, wherein performing the multi-intent mapping includes:
selecting one piece of the DM intent from the DM intent list according to the matched multi-mapping rule or mapping the plurality of pieces of the DM intent to new DM intent.

7. The method of claim 5, wherein the pattern of the DM intent list is characterized in that the plurality of pieces of the DM intent included in the DM intent list is present regardless of an order described by the user.

8. The method of claim 5, wherein performing the multi-intent mapping includes:
applying a multi-mapping rule that matches first among the preset multi-mapping rules to the pattern of the DM intent list.

9. The method of claim 5, wherein performing the multi-intent mapping includes:
generating no result according to the multi-intent mapping when none of the preset multi-mapping rules match the DM intent list.

10. A dialog system, comprising:
a natural language understanding (NLU) module configured to extract at least one piece of NLU intent from an utterance of a user;
an intent mapping module configured to map each of the at least one piece of NLU intent to dialog manager (DM) intent, and generate a DM intent list when a plurality of pieces of the NLU intent is extracted from the utterance of the user, wherein the DM intent list includes the DM intent mapped to each of the plurality of pieces of the NLU intent; and
a multi-intent mapping module configured to perform multi-intent mapping on a plurality of pieces of the DM intent included in the DM intent list.

11. The system of claim 10, wherein intent mapping module is configured to map the NLU intent to the DM intent according to a preset mapping rule for a specific context and condition acquired during a conversation with the user.

12. The system of claim 10, wherein the multi-intent mapping module is configured to perform the multi-intent mapping according to a matched multi-mapping rule among preset multi-mapping rules for a condition corresponding to a pattern of the DM intent list under a specific context.

13. A computer-readable recording medium storing instructions, wherein the instructions, when executed by the computer, cause the computer to:
extract at least one piece of natural language understanding (NLU) intent from an utterance of a user; and
map each of the at least one piece of NLU intent to dialog manager (DM) intent,
wherein, when a plurality of pieces of the NLU intent is extracted from the utterance of the user, the instructions further cause the computer to:
generate a DM intent list, wherein the DM intent list includes the DM intent mapped to each of the plurality of pieces of the NLU intent; and
perform multi-intent mapping on a plurality of pieces of the DM intent included in the DM intent list.
